(19) United States
(12) Patent Application Publication
(10) Pub. No.: US 2008/0295705 A1
(43) Pub. Date: Dec. 4, 2008

(54) MAKING BAKED SPRING ROLLS DEVICE AND METHODS

(76) Inventor: Jing-Yau Chung, Houston, TX (US)

Correspondence Address: MARK A OATHOUT, 3701 KIRBY DRIVE, SUITE 960, HOUSTON, TX, 77098, US

(21) Appl. No.: 12/127,075

(22) Filed: May 27, 2008

Related U.S. Application Data
(60) Provisional application No. 60/941,164, filed on May 31, 2007.

(51) Int. Cl. A21B 1/00; A21B 5/00; A21B 1/48; A21D 6/00

(52) U.S. Cl. 99/352; 99/427; 99/443 R; 426/523; 426/240

(57) ABSTRACT

Spring rolls are baked by a plurality of food grade rollers connected together to form a moving loop. The food grade rollers have an axis for rotating each of the plurality of food grade rollers about the axis which is connected at a center of each of the plurality of food grade rollers. A heating element is mounted along the moving loop and aligned eccentrically from the moving loop proximate two ends of each of the spring rolls to be baked.

### CROSS-REFERENCE TO RELATED APPLICATIONS

This application claims the benefit of U.S. provisional application No. 60/941,164 filed May 31, 2007.

### STATEMENTS REGARDING FEDERALLY SPONSORED RESEARCH OR DEVELOPMENT

Not Applicable.

### REFERENCE TO A MICROFICHE APPENDIX

Not Applicable.

### BACKGROUND

In the U.S. markets, both spring rolls and egg rolls are available in the retail supermarkets and restaurants. The main difference between the spring roll and the egg roll is that a spring roll is made of a thin cooked skin, while an egg roll is made of a thicker raw skin. In fact a spring roll is some times referred to as a thin skin egg roll in the Asian communities. The current invention is applicable to both spring rolls and egg rolls, although for simplicity, discussions will be mainly focused on the spring rolls.

Spring rolls are fried pastries that can be found in several Asian countries, most notably China, Vietnam, the Philippines, and Indonesia (see WIKIPEDIA website encyclopedia for spring roll search) with the exception of the un-fried Vietnamese spring roll which has cooked skin and is served un-fried in some U.S. restaurants. The commercial packaged Asian spring rolls (or sometimes called lumpias) which are retailed in the U.S. supermarkets are generally pre-fried by the manufacturer. The bulk-packaged Asian spring rolls for institutional applications, on the other hand, are generally not pre-fried by the manufacturer with a rare exception of the CHUNG'S spring rolls manufactured by the author's food manufacturing plant in the U.S. in the 1980's. The institutional packaged non-pre-fried spring roll, however, is always deep fried by the customer (e.g. the restaurant) before it is served to the end user.

So far, none of the commercial Asian spring roll or egg roll products has been prepared by baking by the manufacturer, although the end users could heat up the spring rolls by baking. The reason for not prepared by baking by the manufacturer is due to the fact that the manufacturers' baking process by means of the conventional baking equipment for spring rolls or egg rolls, such as an oven will make the spring roll too dry to be further prepared by the end user with either deep frying or baking. A conventional conveyor baking system such as that for baking cookie or biscuit etc. will not work for baking the spring rolls or egg rolls either, because of the fact that unlike cookie or biscuit which consists of raw dough with high moisture content, the spring roll or egg roll skin is generally much drier and tends to dry out quickly during the baking process.

The current invention(s) involve(s) a method and a device for manufacturing a newly invented baked spring roll or baked egg roll.

### BRIEF SUMMARY

Spring rolls are baked by a plurality of food grade rollers connected together to form a moving loop. The food grade rollers have an axis for rotating each of the plurality of food grade rollers about the axis which is connected at a center of each of the plurality of food grade rollers. A heating element is mounted along the moving loop and aligned eccentrically from the moving loop proximate two ends of each of the spring rolls to be baked.

For purposes of this disclosure the terms “blacken” and “blacken the ends” is meant to be inclusive of browning, deep browning and blackening. The term “spring roll” shall be considered to include spring roll(s), egg roll(s), and lumpia(s). “The ends” of a spring roll, refers to the two end sections of a cylindrically shaped spring roll having ⅛ inch to ¼ inch in length for each end section.

### BRIEF DESCRIPTION OF THE SEVERAL VIEWS OF THE DRAWING

FIG. 1a is a top view of one embodiment of the device.

FIG. 1b is a side view of the embodiment of FIG. 1a.

FIG. 2a is a top view of another embodiment of the device.

FIG. 2b is a side view of the embodiment of FIG. 2a.

FIG. 3a is a top view of another embodiment of the device.

FIG. 3b is a side view of the embodiment of FIG. 3a.

### DETAILED DESCRIPTION OF THE EMBODIMENT(S) SHOWN IN THE DRAWINGS

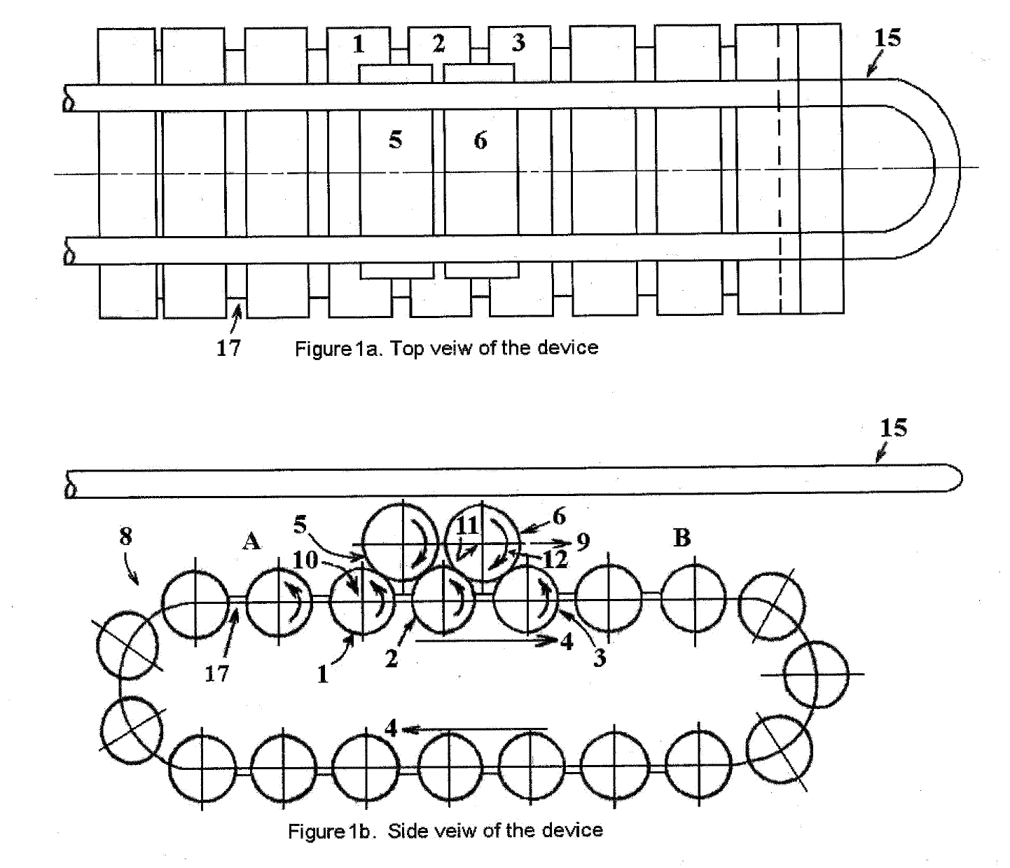

One of the embodiments of the current invention is shown in FIGS. 1a and 1b, where a group of equally-spaced cylindrical stainless steel, ceramic or other food grade rollers 1, which are connected together (represented schematically as unions or connections 17), form a moving loop 8. Each roller 1 rotates about its axis, for example, roller 1 rotates about its axis 10. The roller 1 group travels on loop 8 in the direction indicated by 4. In the current baking process, spring rolls are placed on the roller 1 group, for example, spring roll 5 is placed on rollers 1 and 2, and spring roll 6 is placed on rollers 2 and 3 as depicted in FIGS. 1a and 1b. spring rolls 5 and 6 are moved by the moving loop 8 in direction 9 which is in the same direction as direction 4, as depicted in FIG. 1b. A heating element 15 aligned in the same direction of loop 8 within the baking section AB, is placed above spring rolls 5 and 6 in the vicinity of the two ends of the cylindrically shaped spring rolls 5 and 6 as depicted in FIGS. 1a and 1b. Heating element 15 is arranged in such ways that only the two ends of the spring rolls 5 and 6 are baked significantly, while the main bodies of the spring rolls are baked only slightly. The degree of baking the ends of the spring rolls 5, 6 as well as their main bodies is controlled by the location and the distance of the heating element 15 relative to the spring rolls as well as the temperature of the heating element 15. In the current embodiment, the heating element 15 is placed above the spring rolls at the vicinity of the ends of the spring rolls. It is desirable to significantly blacken the ends of the spring rolls while keeping the main bodies of the spring rolls only slightly baked.

In one embodiment the surface of heating element 15 may be located within one inch or less from the surface of the spring rolls 5, 6 and one having ordinary skill in the art will know how to establish the preferable temperature of the heating element 15 and speed of the moving loop 8. The moving loop 8 is continuously moving whereby it forms a continuously moving surface during the baking process. The rotation of each roller 1 about its axis is preferable but optional, for example, roller 1 may be stationary about its axis 10.

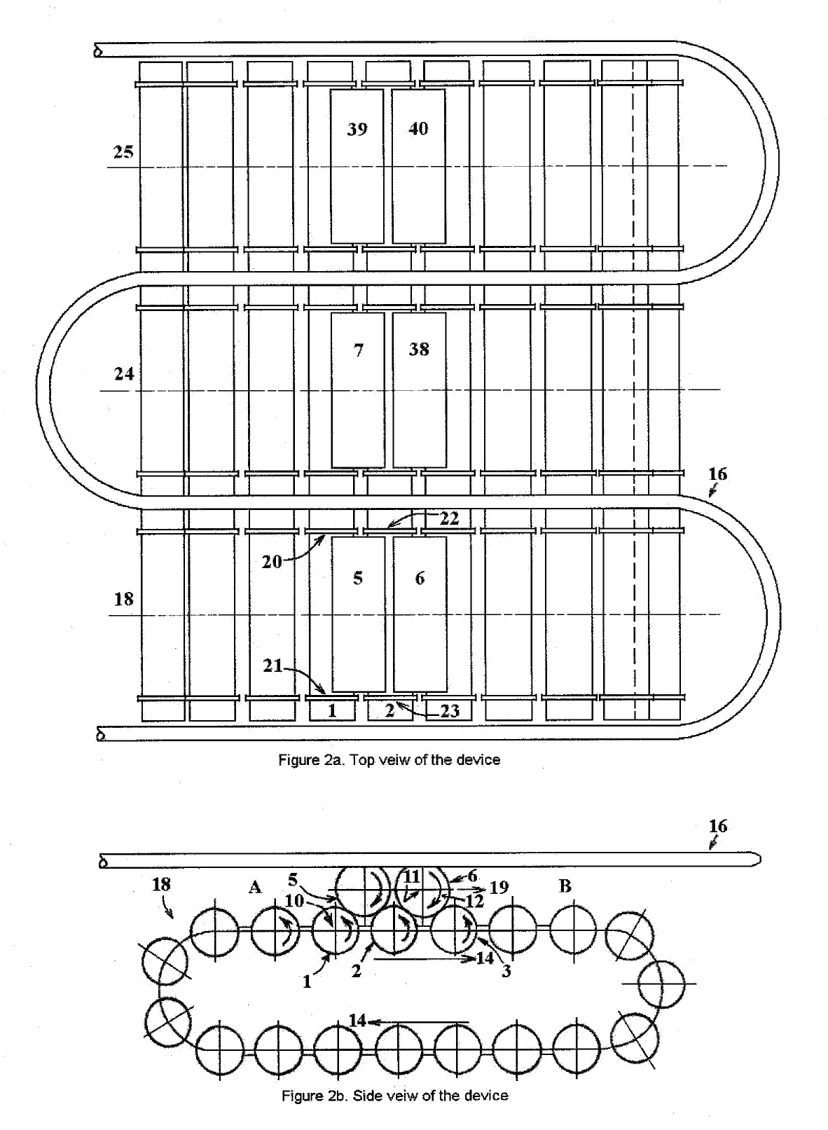

FIGS. 2a and 2b show another embodiment of the current device. In this embodiment, multiple loop 18 which consists of individual loops 18, 24 and 25 moving in the direction 14 are used to convey, for example, the spring rolls 5, 6, 7, 38, 39 and 40 as shown in FIGS. 2a and 2b, in direction 19 which is in the same direction as direction 14 as shown in FIG. 2b. The three individual loops 18, 24 and 25 can be constructed by three separate conveyors or they can be established on a single conveyor with three partitions which form the three loops. Such partitions can be established by means of e.g. rings 20, 21 on roller 1 and rings 22 and 23 on roller 2 as shown in FIG. 2a. The rings 20, 21, 22 and 23 confine the spring rolls 5 and 6 within a guided track, thus constitute a segment of the loop 18. As shown in FIG. 2a, rings 20 and 21 keep spring roll 5 from rolling off the track on roller 1, while rings 22 and 23 keep both spring roll 5 and spring roll 6 from rolling off the track on roller 2. In the case that the three individual loops are constructed by three separate conveyors, different loops may move at different speeds. In the case all three loops are constructed on a single conveyor as shown in FIG. 2a, all three loops 18, 24 and 25 move at the same speed 14. The height of the ring (the outer diameter of the ring) may be extended to become very close to the surface of the adjacent rollers to provide a better confinement of the spring rolls within the track on the rollers. In this configuration, to keep the adjacent rings from touching each other on their outer rims, the rings may be purposely miss-aligned and overlapped each other. Another way of avoiding the rings from touching each other on their outer rims is to maximize the height of a given set of rings and to minimize the height of their adjacent rings. Furthermore, the diameter of the roller may be made slightly smaller at the middle of the roller within any given track, and it increases gradually towards the two side-edges of the roller to keep the spring roll from rolling away from the track. The partitions for confining the spring rolls in the tracks can also be established by a series of non-moving wires or metal strips (not shown in FIG. 2a or 2b) which are installed parallel to the tracks on the two side-edges of the tracks. Such wires or metal strips are built on the non-moving frame of the device and serve the similar purpose as the rings for confining the spring rolls within the tracks. As depicted in FIG. 2a, a series of heating elements 16 are placed in between the multiple rows of the spring rolls on the multiple loops, for example, between spring rolls 5 and 7, between spring rolls 7 and 39, between spring rolls 6 and 38 and between spring rolls 38 and 40. It should be noted that heating element 16 may be placed either above or at the similar level of the spring rolls. FIG. 2a also shows that the heating element 16 is placed at outside of each of the outer ends of spring rolls 5, 6, 39 and 40. In this embodiment, only the ends of the spring rolls 5, 6, 7, 38, 39 and 40 are baked significantly, while the main bodies of the spring rolls are baked slightly. The degree of baking the ends of the spring rolls 5, 6, 7, 38, 39 and 40 as well as their main bodies is controlled by the distance of the heating element relative to the ends of the spring rolls as well as the temperature of the heating element. Again, it is desirable to significantly blacken the ends of the spring rolls only while keeping the main bodies only slightly baked. It should be noted that even if the main bodies of the spring rolls are not significantly exposed to the heating element 16 as in the current embodiment, the main bodies will be baked to some degree due to convective heat transfer within the confinement of the baking device and the radiation heat transfer indirectly reflected from the walls of the baking device.

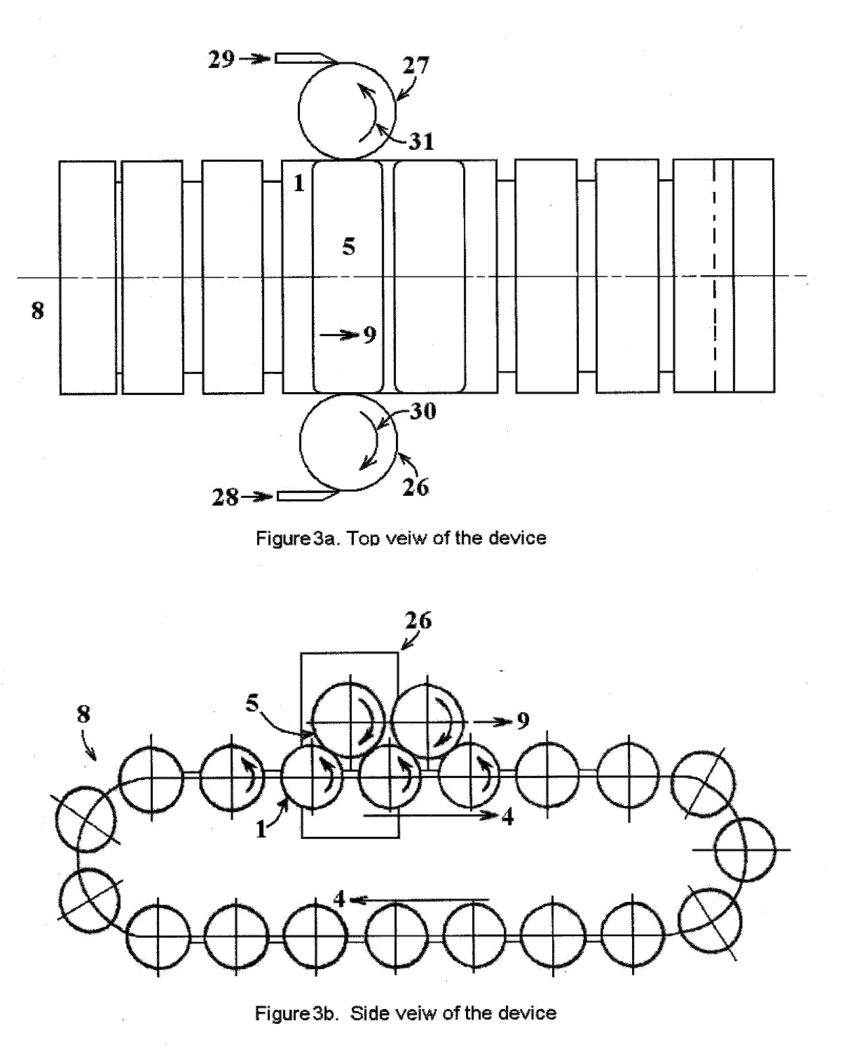

Shown in FIGS. 3a and 3b is another embodiment of the current device. Similar to the embodiment shown in FIGS. 1a and 1b, e.g. spring roll 5 is conveyed by loop 8 moving in direction 9 within the baking track consisting roller group 1 as shown in FIGS. 3a and 3b, spring roll 5 being moved by loop 8 in direction 9 is moving in the same direction 4 of loop 8. In the current embodiment, cylindrical roller heaters e.g. roller heaters 26 and 27 are installed on the stationary frame of the baking device. The axes of the roller heaters are in the direction perpendicular to loop 8 and the roller heaters are placed at the vicinity of the two side-edges of the loop such that both roller heaters 26 and 27 are in direct contact with the two ends of e.g. spring roll 5 as depicted in FIGS. 3a and 3b. The roller heaters 26 and 27 are used to bake the two ends of spring roll 5 by directly rolling over the two ends of the moving spring roll with a synchronized rotational movement with moving directions shown by the arrows 30 and 31 for roller heater 26 and 27 respectively as shown in FIG. 3a. The degree of baking the ends of spring rolls 5 is controlled by the temperature and the moving speed of loop 8. With this embodiment, only the ends of the spring rolls are baked and the main body of the spring roll will not be baked. A pair of heater cleaners 28 and 29 may be installed at roller heater 26 and 27 respectively as shown in FIG. 3a, to scratch off particles picked up by the roller heaters from the spring roll skin during the heating process. The roller heater can also be replaced by a non-rolling heater such as a thin stationary heater strip which lightly Contacts the moving spring rolls in the heating process.

Prior to baking, the spring roll skins may be applied with various food grade oil, spice or food-color (preferably all natural food ingredients). The applications of such food grade oil, spice or food-color may be achieved by an automatic spraying system which sprays such substances on the spring roll skins. Or such substances may be added in the dough while making the dough-based skins. One of ordinary skill in the art has knowledge of how to apply the food grade oil, spice and/or food color sufficiently for preparation of a baked spring roll having proper moisture, flavor and color.

The skin of the spring roll may be fully cooked, slightly cooked or even raw before the spring roll is baked by the current device. The current invention can also apply to other cylindrical or rounded shaped food products having dough-based exterior.

What is claimed is:

1. A method for preparing a spring roll, comprising the steps of:
moving the spring roll across a continuous moving surface; and
baking the spring roll, performed simultaneous with said step of moving the spring roll.

2. The method according to claim 1, further comprising the step of rotating the spring roll around a center axis of the spring roll, performed simultaneous with said step of moving the spring roll.

3. The method according to claim 1, further comprising the step of applying food grade oil to the spring roll performed prior to said step of baking the spring roll.

4. The method according to claim 1, wherein said step of baking the spring roll is performed by heating an end of the spring roll by convection, radiation and conduction via a heating element.

5. The method according to claim 4, wherein said step of baking the spring roll by convectively heating the end of the spring roll by the heating element further comprises not baking a middle portion of the spring roll.

6. An apparatus for baking a spring roll, comprising:
a plurality of food grade rollers connected together to form a moving loop;
a means for rotating each of the plurality of food grade rollers about an axis connected at a center of each of the plurality of food grade rollers;
at least one heating element mounted along the moving loop and aligned eccentrically from the moving loop proximate two ends of each of the spring rolls to be baked.

7. The apparatus according to claim 6 further including a second moving loop including a second plurality of food grade rollers connected together.

8. The apparatus according to claim 6 wherein the heating element is positioned one inch or less from the surface of each of the spring rolls to be baked.

9. The apparatus according to claim 8 wherein the heating element is positioned above and projecting over the spring rolls to be baked.

10. The apparatus according to claim 8 wherein the heating element is positioned with an axis perpendicular and contiguous to the ends of spring rolls to be baked.
